(19) United States
(12) Patent Application Publication
(10) Pub. No.: US 2025/0013178 A1
(43) Pub. Date: Jan. 9, 2025

(54) ELECTROPHOTOGRAPHIC MEMBER, FIXING APPARATUS AND ELECTROPHOTOGRAPHIC IMAGE FORMING APPARATUS

(71) Applicant: CANON KABUSHIKI KAISHA, Tokyo (JP)

(72) Inventors: RYUNOSUKE KAWAHARA, Ibaraki (JP); TOMOYO MIYAKAI, Tokyo (JP); KOSUKE TANAKA, Chiba (JP); AKESHI ASAKA, Chiba (JP)

(21) Appl. No.: 18/744,797

(22) Filed: Jun. 17, 2024

(30) Foreign Application Priority Data
Jun. 27, 2023 (JP) 2023-104709

(51) Int. Cl. G03G 15/20

(52) U.S. Cl. CPC G03G 15/2057; G03G 15/2064; G03G 2215/2051

(57) ABSTRACT

An electrophotographic member has a base layer, an elastic layer on the base layer, and a surface layer on the elastic layer. The surface layer includes a fluorocarbon resin. With a DSC measurement using a sample sampled from the surface layer, temperature raising and temperature lowering are performed twice at 25 to 400° C., resulting in a first DSC chart at the first temperature raising, and a second DSC chart at the second temperature raising. The first DSC chart has at least two endothermic peaks and T1° C. represents the peak top temperature of the peak on the highest temperature side of them. The second DSC chart has at least one endothermic peak and T2° C. represents the peak top temperature of the largest endothermic peak of them. The T1 and the T2 satisfy the following formula (1):

T1>T2 (1).

### BACKGROUND OF THE INVENTION

### Field of the Invention

The present disclosure relates to an electrophotographic member for use in a fixing apparatus of an electrophotographic image forming apparatus, and a fixing apparatus including the electrophotographic member and an electrophotographic image forming apparatus.

### Description of the Related Art

As the electrophotographic member such as a fixing member for use in a fixing apparatus of an electrophotographic image forming apparatus such as a printer, a copier, or a facsimile, there is a film shaped or roller shaped one. As the fixing member, there is known the one configured such that, for example, on a film-shaped or roller-shaped base material made of a heat-resistant resin or made of a metal, if required, an elastic layer or a surface layer including heat-resistant rubber, or the like is formed. For example, for the surface layer, a fluorocarbon resin having releasability, or the like is used.

The elastic layer functions as a layer for imparting the flexibility to the fixing member in order to ensure the fixing nip in the fixing apparatus, or in order to allow the surface of the fixing member to follow the unevenness of paper. Further, for the surface layer, as a fluorocarbon resin having excellent releasability with respect to the toner, tetrafluoroethylene-perfluoro alkyl vinyl ether copolymer (PFA) is preferably used. In recent years, from the viewpoint of reduction of the running cost and energy conservation, the fixing member has been required to have a longer life. Particularly, the surface layer of the fixing member tends to undergo wear due to the paper sheet end, which largely affects the life of the fixing member.

Japanese Patent Application Publication No. 2007-093650 proposes the technology of coating the core metal with PFA, and then, performing heating to a temperature equal to or higher than the melting point of the PFA, followed by gradual cooling, thereby increasing the degree of crystallinity of the PFA, for improving the wear resistance.

### SUMMARY OF THE INVENTION

As in Japanese Patent Application Publication No. 2007-093650, the fixing member is heated to a temperature equal to or higher than the melting point of PFA, i.e., the surface layer, followed by gradual cooling, which can increase the degree of crystallinity of PFA, and can improve the wear resistance against the paper sheet. However, according to the study by the present inventors, when PFA is gradually cooled, the crystal growth rate increases relative to the frequency of occurrence of the spherulite nucleus, and hence a large spherulite may be formed on the surface of the surface layer. Then, the unevenness increases along the spherulite shape, so that the surface smoothness of the fixing member is reduced. For this reason, the unevenness of the surface of the surface layer is transferred onto the image surface, unfavorably resulting in a problem of the reduction of the image gloss value.

At least one aspect of the present disclosure is targeted for an electrophotographic member capable of providing a favorable image quality with a high image gloss value while improving the wear resistance of the surface layer against a paper sheet. Further, at least another aspect of the present disclosure is targeted for a fixing apparatus capable of providing a favorable image quality with a high image gloss value while improving the wear resistance of the surface layer against a paper sheet, and an electrophotographic image forming apparatus including the fixing apparatus.

At least one aspect of the present disclosure relates to an electrophotographic member comprising:
a base layer;
an elastic layer on the base layer, and
a surface layer on the elastic layer, wherein
the surface layer comprises a fluorocarbon resin, when heat amount measurement in which the following steps (1) to (4) are sequentially performed with a sample sampled from the surface layer as a measurement sample using a differential scanning calorimeter (DSC),
step (1): a first temperature raising step of heating the measurement sample from a temperature of 25° C. to a temperature of 400° C. at a ramp rate of 20° C./min;
step (2): a first temperature lowering step of cooling the measurement sample heated to a temperature of 400° C. at the step (1) to a temperature of 25° C. at a ramp down rate of 20° C./min; and step (3): a second temperature raising step of raising the temperature of the measurement sample set at a temperature of 25° C. at the step (2) to a temperature of 400° C. at a ramp rate of 20° C./min;
step (4): a second temperature lowering step of cooling the measurement sample heated to a temperature of 400° C. at the step (3) to a temperature of 25° C. at a ramp down rate of 20° C./min;
a first DSC chart obtained at the step (1) has at least two endothermic peaks, P1 represents a endothermic peak situated on a higher temperature side when two endothermic peaks are selected sequentially from the largest one of the at least two endothermic peaks, P2 represents a endothermic peak situated on a lower temperature side of the two endothermic peaks, T1° C. represents a peak top temperature of the P1, and t1° C. represents a peak top temperature of the P2, and
a second DSC chart obtained at the step (3) has at least one endothermic peak, and T2° C. represents a peak top temperature of the largest endothermic peak of the at least one endothermic peak, then,
the T1 and the T2 satisfy the following formula (1):

$$T 1 > T 2. \qquad ( 1 )$$

At least one aspect of the present disclosure relates to a fixing apparatus in an electrophotographic image forming apparatus,
the fixing apparatus comprising a fixing member; and a pressurizing member arranged opposed to the fixing member, wherein
at least one of the fixing member and the pressurizing member is the above electrophotographic member.

At least one aspect of the present disclosure relates to an electrophotographic image forming apparatus comprising a fixing apparatus, wherein
the fixing apparatus includes a fixing member; and a pressurizing member arranged opposed to the fixing member, and
at least one of the fixing member and the pressurizing member is the above electrophotographic member.

At least one aspect of the present disclosure can provide an electrophotographic member capable of providing a favorable image quality with a high image gloss value while improving the wear resistance of the surface layer against a paper sheet. Further, at least another aspect of the present disclosure can provide a fixing apparatus capable of providing a favorable image quality with a high image gloss value while improving the wear resistance of the surface layer against a paper sheet, and an electrophotographic image forming apparatus including the fixing apparatus.

Further features of the present invention will become apparent from the following description of exemplary embodiments with reference to the attached drawings.

### BRIEF DESCRIPTION OF THE DRAWINGS

FIG. 1 is a schematic view of an image forming apparatus;

FIG. 2 is a schematic view of a fixing apparatus;

FIG. 3 is a schematic view of a fixing film; and

FIG. 4 is one example of the DSC chart of a surface layer sample.

### DESCRIPTION OF THE EMBODIMENTS

In the present specification, the term “from XX to YY” or “XX to YY” indicative of the numerical value range means the numerical value range including the lower limit and the upper limit, i.e., the endpoints unless otherwise specified. Further, when the numerical value range is described in steps, the upper limits and the lower limits of respective numerical value ranges can be arbitrarily combined. Below, the embodiments of the present disclosure will be described in detail. Incidentally, the technical scope of the present disclosure is not limited to the following description.

As described in Japanese Patent Application Publication No. 2007-093650, by heating the fixing member to a temperature equal to or higher than the melting point of PFA, i.e., the surface layer, followed by gradual cooling, it is possible to increase the degree of crystallinity of PFA, and it is possible to improve the wear resistance against a paper sheet. However, according to the study by the present inventors, when PFA is gradually cooled, the crystal growth rate increases relative to the frequency of occurrence of the spherulite nucleus. Accordingly, a large spherulite may be formed. When a large spherulite of PFA is formed in the surface layer, the unevenness of the surface increases along the shape of the large spherulite, resulting in the reduction of the surface smoothness of the fixing member. As a result, the unevenness of the surface of the surface layer is transferred onto the surface of a toner image at the time of fixing. This may result in the reduction of the image gloss value of an electrophotographic image.

Under such circumstances, the present inventors conducted a close study for obtaining an electrophotographic member with a high surface smoothness while having an excellent wear resistance owing to the inclusion of the spherulite of PFA. As a result, the present inventors found that an electrophotographic member having the following configuration can combine an excellent wear resistance and high surface smoothness.

### Configuration

At least one aspect of the present disclosure relates to an electrophotographic member comprising:
a base layer;
an elastic layer on the base layer, and
a surface layer on the elastic layer, wherein
the surface layer comprises a fluorocarbon resin,
when heat amount measurement in which the following steps (1) to (4) are sequentially performed with a sample sampled from the surface layer as a measurement sample using a differential scanning calorimeter (DSC),
step (1): a first temperature raising step of heating the measurement sample from a temperature of 25° C. to a temperature of 400° C. at a ramp rate of 20° C./min;
step (2): a first temperature lowering step of cooling the measurement sample heated to a temperature of 400° C. at the step (1) to a temperature of 25° C. at a ramp down rate of 20° C./min; and
step (3): a second temperature raising step of raising the temperature of the measurement sample set at a temperature of 25° C. at the step (2) to a temperature of 400° C. at a ramp rate of 20° C./min;
step (4): a second temperature lowering step of cooling the measurement sample heated to a temperature of 400° C. at the step (3) to a temperature of 25° C. at a ramp down rate of 20° C./min;
a first DSC chart obtained at the step (1) has at least two endothermic peaks, P1 represents a endothermic peak situated on a higher temperature side when two endothermic peaks are selected sequentially from the largest one of the at least two endothermic peaks, P2 represents a endothermic peak situated on a lower temperature side of the two endothermic peaks, T1° C. represents a peak top temperature of the P1, and t1° C. represents a peak top temperature of the P2, and
a second DSC chart obtained at the step (3) has at least one endothermic peak, and T2° C. represents a peak top temperature of the largest endothermic peak of the at least one endothermic peak, then,
the T1 and the T2 satisfy the following formula (1):

$$T 1 > T 2. \qquad ( 1 )$$

The reason why an electrophotographic member having the foregoing configuration can combine an excellent wear resistance and high surface smoothness will be described later.

### Fixing Member

An electrophotographic member which is at least one aspect of the present disclosure is, for example, a fixing member. For example, the electrophotographic member is a fixing belt. Further, the electrophotographic member may be an electrophotographic belt having an endless shape. The electrophotographic member has at least a base layer, an elastic layer, and a surface layer in this order. Namely, the electrophotographic member has a base layer, an elastic layer on the base layer, and a surface layer on the elastic layer. Between respective layers of the base layer, the elastic layer, and the surface layer, and on the inner circumferential surface side of the base layer and the outer circumferential surface side of the surface layer, if required, other layers may be provided.

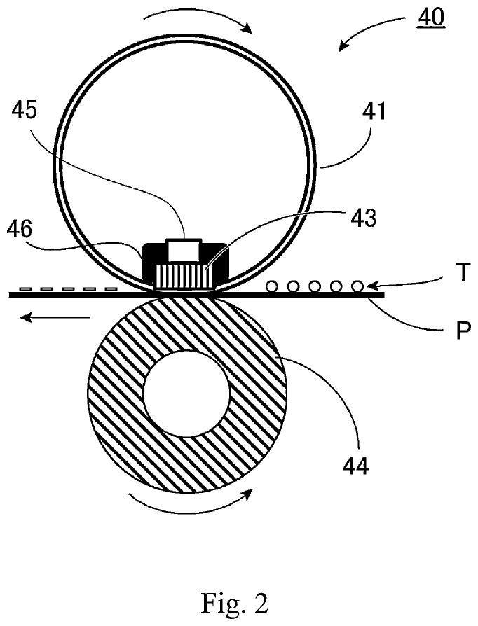

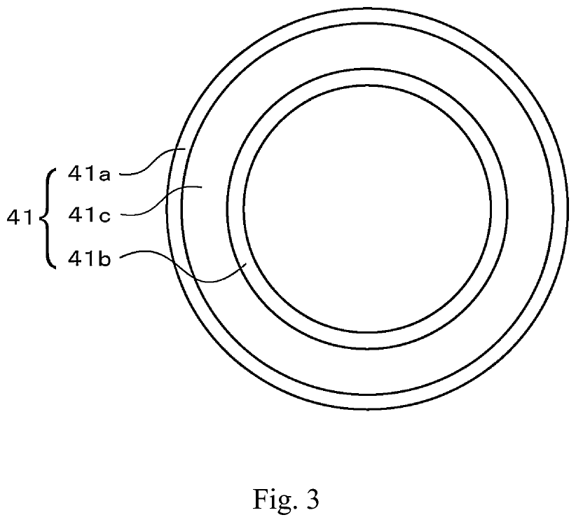

A fixing member 41 in accordance with one aspect of the present disclosure can be, for example, a fixing film 41 as shown in, for example, FIGS. 2 and 3. The fixing member 41 having an endless shape has a base layer 41b, an elastic layer 41c, and a surface layer 41a. The surface layer 41a can be, for example, a release layer having releasability with respect to a toner, or the like. The surface layer 41a can form the outer surface of an electrophotographic member. Incidentally, the surface layer 41a may be bonded to the surface of the elastic layer 41c by an adhesion layer not shown. Further, on the inner circumferential surface side of the base layer 41b, an inner surface sliding layer not shown may be included.

Below, respective layers will be described specifically.

### Base Layer

As the material for the base layer 41b, the known one as the electrophotographic member may be used, and there is no particular restriction. For example, a metal such as aluminum, iron, stainless steel (SUS), or nickel, and an alloy thereof, and a heat-resistant resin such as polyimide are used. Stainless steel is preferable. Although the thickness of the base layer 41b has no particular restriction, it is preferably set at from 20 μm to 100 μm, and more preferably set at from 20 μm to 50 μm from the viewpoint of, for example, the strength, the flexibility, and the heat capacity.

The outer surface of the base layer 41b may be subjected to a surface treatment in order to be imparted with the adhesion with the elastic layer 41c. For the surface treatment, physical treatments such as a blast treatment, a lapping treatment, and polishing, and chemical treatments such as an oxidation treatment, a coupling agent treatment, and a primer treatment can be used alone, or in combination of a plurality thereof.

When the surface of the base layer 41b is provided with the elastic layer 41c including silicone rubber, in order to improve the adhesion between the base layer 41b and the elastic layer 41c, the surface of the base layer 41b is preferably subjected to a primer treatment. Examples of the primer for use in the primer treatment may include a paint obtained by appropriately mixing and dispersing a silane coupling agent, a silicone polymer, hydrogenated methyl siloxane, alkoxy silane, a reaction promoting catalyst, and a colorant such as red iron oxide in an organic solvent.

The primer can be appropriately selected according to the material for the base layer 41b, the kind of the elastic layer 41c, or the form of the crosslinking reaction. Particularly, when the elastic layer 41c includes an unsaturated aliphatic group in a large amount, a primer including a hydrosilyl group is preferably used in order to impart the adhesion by the reaction with an unsaturated aliphatic group. When the elastic layer 41c includes a hydrosilyl group in a large amount, a primer including an unsaturated aliphatic group is preferably used.

As the primers, other than these, mention may be made of those including an alkoxy group. As the primer, a commercially available product can be used. Further, the primer treatment includes a step of coating the primer onto the outer surface of the base layer 41b (the adhesion surface with the elastic layer 41c), and performing drying or burning.

### Inner Surface Sliding Layer

On the inner circumferential surface side of the base layer 41b, an inner surface sliding layer may be provided. As the inner surface sliding layer, a resin combining high durability and a high heat resistance as with a polyimide resin is suitable. The inner surface sliding layer is gradually worn by being rubbed, and accordingly, preferably has a thickness enough to enable acting as a sliding layer through the use durability test. On the other hand, a thickness not preventing the heat supply from a heater is preferable. For this reason, the thickness is preferably 5 to 20 μm, and more preferably 10 to 15 μm. The inner surface sliding layer may be formed using a known coating method, or the like.

### Elastic Layer

For the elastic layer 41c, a known one as an electrophotographic member may be used, and there is no particular restriction. The elastic layer 41c preferably includes silicone rubber excellent in heat resistance. Further, as the raw material for silicone rubber, addition curable liquid silicone rubber is preferably used. The elastic layer 41c can be formed by, for example, coating addition curable liquid silicone rubber onto the outer surface of the base layer 41b, and performing heating and curing. The coating method has no particular restriction, and a known method may be used.

The thickness of the elastic layer 41c can be appropriately designed in consideration of the surface hardness of the fixing member, and the width of the fixing nip part to be formed, and is preferably from 100 μm to 500 μm, and further preferably from 200 μm to 400 μm.

As the silicone rubber, for example, a cured product of an addition curable liquid silicone rubber mixture described later can be used. The elastic layer 41c can be formed by coating/heating a liquid silicone rubber mixture with a known method.

A liquid silicone rubber mixture usually contains the following components (a) to (d):
Component (a): an organopolysiloxane having an unsaturated aliphatic group;
Component (b): an organopolysiloxane having active hydrogen bonded with silicon;
Component (c): a catalyst;
Component (d): a thermally conductive filler

Each component will be described below.

### Component (a)

An organopolysiloxane having an unsaturated aliphatic group is an organopolysiloxane having an unsaturated aliphatic group such as a vinyl group, and examples thereof include those represented by the following formulas (1) and (2). The organopolysiloxane having an unsaturated aliphatic group is preferably linear.

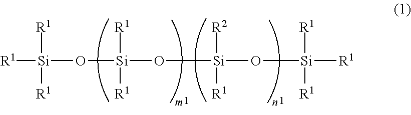

In formula (1), m¹ represents an integer of 0 or more, and n¹ represents an integer of 3 or more. Further, in structural formula (1), each R¹ independently represents a monovalent unsubstituted or substituted hydrocarbon group containing no unsaturated aliphatic group, provided that at least one of R¹ represents a methyl group and each R² independently represents an unsaturated aliphatic group.

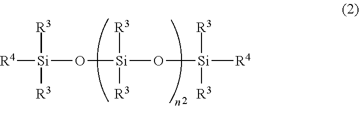

In formula (2), n² represents a positive integer, and each R³ independently represents a monovalent unsubstituted or substituted hydrocarbon group containing no unsaturated aliphatic group, provided that at least one of R³ represents a methyl group, and each R⁴ independently represents an unsaturated aliphatic group.

In formulas (1) and (2), examples of the monovalent unsubstituted or substituted hydrocarbon group containing no unsaturated aliphatic group, which can be represented by R¹ and R³, include the following groups.

### Unsubstituted Hydrocarbon Group

Alkyl group (for example, methyl group, ethyl group, propyl group, butyl group, pentyl group, and hexyl group).

Aryl group (for example, phenyl group).

### Substituted Hydrocarbon Group

Substituted alkyl group (for example, chloromethyl group, 3-chloropropyl group, 3,3,3-trifluoropropyl group, 3-cyanopropyl group, and 3-methoxypropyl group).

The organopolysiloxanes represented by formulas (1) and (2) have at least one methyl group directly bonded to the silicon atom forming the chain structure. However, 50% or more of each of R¹ and R³ are preferably methyl groups, and more preferably all R¹ and R³ are methyl groups, for ease of synthesis and handling.

Also, examples of unsaturated aliphatic groups that can be represented by R² and R⁴ in formulas (1) and (2) include the following groups. Examples of unsaturated aliphatic groups include a vinyl group, an allyl group, a 3-butenyl group, a 4-pentenyl group, and a 5-hexenyl group. Among these groups, both R² and R⁴ are preferably vinyl groups because synthesis and handling are facilitated, cost is reduced, and a cross-linking reaction can be easily performed.

From the standpoint of moldability, the component (a) preferably has a viscosity of from 1000 mm²/s to 50000 mm²/s. Where the viscosity is less than 1000 mm²/s, it will be difficult to adjust the hardness to the level required for the elastic layer 20c, and where the viscosity is more than 50000 mm²/s, the viscosity of the mixture will be too high, making coating difficult. Viscosity (kinetic viscosity) can be measured using a capillary viscometer, a rotational viscometer, or the like, based on JIS Z 8803:2011.

The blending amount of component (a) is preferably 55% by volume or more from the viewpoint of durability and 65% by volume or less from the viewpoint of heat transfer, based on the liquid silicone rubber mixture used to form the elastic layer 20c.

### Component (b)

The organopolysiloxane having active hydrogen bonded with silicon functions as a cross-linking agent that reacts with the unsaturated aliphatic group of component (a) under the action of a catalyst to form a cured silicone rubber.

Any organopolysiloxane having a Si—H bond can be used as the component (b). In particular, from the viewpoint of reactivity with the unsaturated aliphatic group of component (a), an organopolysiloxane having an average number of silicon-bonded hydrogen atoms of 3 or more per molecule is preferably used.

Specific examples of component (b) include linear organopolysiloxane represented by formula (3) below and cyclic organopolysiloxane represented by formula (4) below.

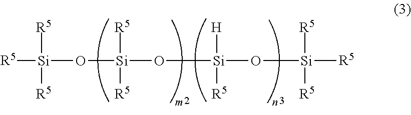

In formula (3), m² represents an integer of 0 or more, n³ represents an integer of 3 or more, and R⁵ each independently represents a monovalent unsubstituted or substituted hydrocarbon group containing no unsaturated aliphatic group.

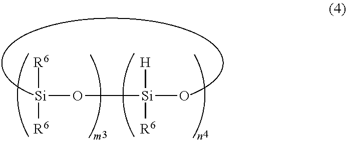

In formula (4), m³ represents an integer of 0 or more, n⁴ represents an integer of 3 or more, and R⁶ each independently represents a monovalent unsubstituted or substituted hydrocarbon group containing no unsaturated aliphatic group.

Examples of monovalent unsubstituted or substituted hydrocarbon groups containing no unsaturated aliphatic group that can be represented by R⁵ and R⁶ in formulas (3) and (4) include the same groups as those mentioned above for R¹ in structural formula (1). Among these, it is preferable that 50% or more of each of R⁵ and R⁶ be a methyl group and more preferably all R⁵ and R⁶ are methyl groups because synthesis and handling are easy and excellent heat resistance is easily obtained.

### Component (c)

Examples of the catalyst used to form the silicone rubber include a hydrosilylation catalyst for accelerating the curing reaction. Known substances such as platinum compounds and rhodium compounds can be used as hydrosilylation catalysts. The blending amount of the catalyst can be appropriately set and is not particularly limited.

### Component (d)

The elastic layer 41c may include a filler. The filler is to be added for controlling the thermal conductivity, the heat resistance, and the modulus of elasticity. As the thermally conductive filler, mention may be made of a metal, a metal compound, or a carbon fiber. A highly thermally conductive filler is further preferable, and specific examples thereof may include the following materials.

Metal silicon (Si), silicon carbide (SiC), silicon nitride (Si₃N₄), boron nitride (BN), aluminum nitride (AlN), alumina (Al₂O₃), iron oxide (Fe₂O₃), zinc oxide (ZnO), magnesium oxide (MgO), titanium oxide (TiO₂), silica (SiO₂), copper (Cu), aluminum (Al), silver (Ag), iron (Fe), nickel (Ni), carbon black (C), a carbon nanotube (C), a gas phase growth method carbon fiber, a PAN type (polyacrylonitrile) carbon fiber, and a pitch type carbon fiber.

### Adhesive Layer

Between the elastic layer 41c and the surface layer 41a, an adhesive layer for bonding them may be provided. The materials for the adhesive layer have no particular restriction, and known ones can be used. The adhesive layer preferably includes a silicone rubber adhesive. Although the thickness of the adhesive layer has no particular restriction, it is preferably 1 to 20 μm, and more preferably 3 to 10 μm.

### Surface Layer

The surface layer 41a includes a fluorocarbon resin. The surface layer 41a is preferably formed of a fluorocarbon resin. The fluorocarbon resin has no particular restriction, and a known one can be used. The fluorocarbon resin can be at least one selected from the group consisting of, for example, PFA, and a tetrafluoroethylene-hexafluoropropylene copolymer (FEP). The surface layer can also include polytetrafluoroethylene (PTFE) in addition to at least one selected from the group consisting of PFA and FEP as a fluorocarbon resin. Further, of PFA and FEP, a tetrafluoroethylene-perfluoro alkyl vinyl ether copolymer (PFA) having a more excellent heat resistance is preferable. Therefore, the fluorocarbon resin in the surface layer preferably includes PFA, and more preferably is PFA.

The PFA has no particular restriction, and a known one can be used. The copolymerization ratio (molar ratio) (PAVE/TFE) between perfluoro alkyl vinyl ether (PAVE) and tetrafluoroethylene (TFE) is preferably 1.5/98.5 to 4.5/95.5, and more preferably 1.5/98.5 to 4.0/96.0. When the surface layer includes PFA, as PFA, two or more materials having different copolymerization ratios between PAVE and TFE may be used.

As PFA, a commercially available one may be used. Specific examples thereof may include “AP-230” (trade name, manufactured by DAIKIN INDUSTRIES Ltd.) and “AP-231SH” (trade name, manufactured by DAIKIN INDUSTRIES Ltd.) that is PFA with the end group fully fluorinated.

Being PFA can be confirmed by, for example, confirming the presence of a peak characteristic of polytetrafluoroethylene (PTFE) in the ATR spectrum of FT-IR, and confirming the presence of a small peak in the vicinity of 994 cm⁻¹ that will not appear for PTFE.

First, the peaks characteristic of PTFE include 1200 cm⁻¹ (CF₂ antisymmetric stretch), 1150 cm⁻¹ (CF₂ symmetric stretch), 640 cm⁻¹ (CF₂ out-of-plane deformation (wagging)), 555 cm⁻¹ (CF₂ in-plane deformation (bending)), and 505 cm⁻¹ (CF₂ in-plane deformation (rocking)). Further, the position of the peak in the vicinity of 994 cm⁻¹ characteristic of PFA changes according to the length of a carbon chain at the perfluoro alkyl vinyl ether portion. In the case of perfluoropropoxy group, the peak appears at 994 cm⁻¹, in the case of a perfluoroethoxy group, the peak appears at 1090 cm⁻¹, and in the case of a perfluoromethoxy group, the peak appears at 881 cm⁻¹.

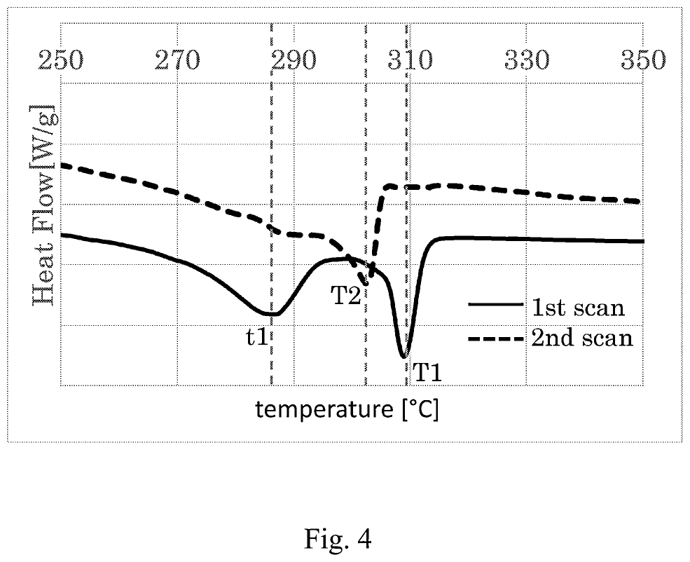

With a sample sampled from the surface layer 41a as a measurement sample, heat amount measurement in which using a differential scanning calorimeter (DSC), the following steps (1) to (4) are sequentially performed is performed. T1 and T2 defined as described below satisfy the following formula (1). One example of the DSC chart is shown in FIG. 4.
Step (1): a first temperature raising step of heating the measurement sample from a temperature of 25° C. to a temperature of 400° C. at a ramp rate of 20° C./min (holding at 400° C. for 5 minutes after temperature raising);
Step (2): a first temperature lowering step of cooling the measurement sample heated to a temperature of 400° C. at the step (1) to a temperature of 25° C. at a ramp down rate of 20° C./min;
Step (3): a second temperature raising step of raising the temperature of the measurement sample set at a temperature of 25° C. at the step (2) to a temperature of 400° C. at a ramp rate of 20° C./min (holding at 400° C. for 5 minutes after temperature raising); and
Step (4): a second temperature lowering step of cooling the measurement sample heated to a temperature of 400° C. at the step (3) to a temperature of 25° C. at a ramp down rate of 20° C./min;

The first DSC chart (denoting the 1st scan of FIG. 4) obtained at the step (1) has at least two endothermic peaks. Two endothermic peaks are selected sequentially from the largest peak of the at least two endothermic peaks. At this step, the peak situated on the higher temperature side is referred to as P1, the endothermic peak situated on the lower temperature side is referred to as P2, the peak top temperature of P1 is referred to as T1° C., and the peak top temperature of P2 is referred to as t1° C. Further, the second DSC chart (denotes the 2nd scan of FIG. 4) obtained at the step (3) has at least one endothermic peak. The peak top temperature of the largest endothermic peak of the at least one endothermic peak is referred to as T2° C. At this step, T1 and T2 satisfy the following formula (1).

$$T 1 > T 2. \qquad ( 1 )$$

The surface layer having at least two endothermic peaks in the first DSC chart obtained at the step (1) indicates the presence of crystals having different melting points.

Then, the surface layer having at least one endothermic peak in the second DSC chart obtained at the step (3) indicates the presence of a crystal with a given melting point.

It is preferable that two endothermic peaks are observed in the first DSC chart. Further, it is preferable that one endothermic peak is observed in the second DSC chart.

As shown in the 1st scan of FIG. 4, in the first DSC chart, first, the peak P2 indicative of t1 appears, and then, the peak P1 indicative of T1 appears. When two peaks thus appear, the peak P2 on the lower temperature side is considered to be the peak resulting from a spherulite with relatively lower stability. Then, the peak P1 appears subsequently at a higher temperature is a peak having higher degree of crystallinity.

With the 1st scan at the first temperature raising step, not one broad peak but definite two peaks appear. This is considered due to the effect of the peak P1 stable and with a higher degree of crystallinity. Namely, the crystal with a higher degree of crystallinity which can become the peak P1 at the first temperature raising step is not dissolved at the temperature at which the peak P2 appears, and crystallization further proceeds at the subsequent temperature raising process to T1. It is considered that at least two peaks are obtained as in FIG. 4 under the influence of the heat generation due to the crystallization.

Accordingly, at the first temperature raising step, at least two peaks appear. This is considered to indicate that crystals having different melting points are present in the surface layer, specifically, that the surface layer includes at least two kinds of crystals having different stabilities. Herein, the stability of a crystal includes, for example, the degree of crystallinity. Incidentally, the peak P1 is considered to be a peak resulting from melting of the whole crystals included in the surface layer including a crystal with a high degree of crystallinity.

Further, the peak appearing in the second DSC chart (2nd scan of FIG. 4) is a peak resulting from the crystal crystallized by quenching at the first temperature lowering step after melting of all the crystals showing the peaks P1 and P2.

Then, T1 and T2 satisfy the formula (1). This indicates that, relative to the crystal corresponding to T2 generated at cooling (first temperature lowering step) of the step (2), the crystal corresponding to T1 is a more stable crystal as compared with the crystal corresponding to T2. Namely, it is indicated that such a surface layer as to satisfy the formula (1) has a high degree of crystallinity. For this reason, it is considered that the wear resistance of the surface layer with respect to a paper sheet becomes favorable.

More specifically, for example, when the surface layer includes PFA, at least two endothermic peaks are observed in the first DSC chart. This indicates the presence of at least two kinds pf PFA crystals having different melting points in the surface layer, and the presence of a PFA crystal having higher stability than that of the PFA crystal generated in the second temperature lowering process.

Further, as described above, the lower endothermic peak P2 of the at least two endothermic peaks in the first DSC chart indicates the presence of a small spherulite. Conceivably, the presence of such a peak P1 as to satisfy the formula (1) in the presence of such a peak P2 indicates that a fluorocarbon resin in an amorphous state, which has not yet reached crystallization, has crystallized under conditions where more stable crystals are formed, resulting in generation of the crystal to be the peak P1 with such a small spherulite as to show the peak P2 present in the surface layer. When the degree of crystallinity is further increased with a small spherulite being present, the presence of the already existing spherulite becomes a barrier, which makes large growth difficult. As a result, a large crystal does not grow in the surface layer, which suppresses the reduction of the surface smoothness of the surface layer caused by a large crystal. For this reason, conceivably, the image gloss value becomes favorable without loss of the surface smoothness of the surface layer.

Therefore, the presence of at least two endothermic peaks in the first DSC chart in connection with satisfaction of the formula (1) is considered to indicate that the degree of crystallinity of the crystal in the surface layer is high, and that the spherulite can be controlled small. Accordingly, it is considered that the wear resistance and the surface smoothness can be combined.

From the viewpoint that T1 approaches the full melting completion temperature, and the reduction of the degree of crystallinity is suppressed, T1 and T2 preferably satisfy the following formula (2).

$$T 1 - T 2 \leq 15 ° C . \qquad ( 2 )$$

T1−T2 is preferably 1 to 15° C., and more preferably 2 to 12° C.

Examples of the method for allowing the surface layer to have crystals having different melting points, and to have at least two endothermic peaks in the first DSC chart may include the following method.

A PFA tube is coated on the surface of the elastic layer 41c, resulting in a surface layer 41a. Then, a first heating treatment is performed. In order to heat the entire electrophotographic member region, for example, an upright and cylindrical heating cylinder capable of performing heating up to 330° C. or more is used. In the inside of the heating cylinder, for example, a band heater including a thermocouple mounted therein is set, and the heating temperature of the fixing member is controlled. For example, a high temperature thermostat (manufactured by ESPEC Co.) can be used. The heating temperature may only be equal to or higher than the full melting completion temperature of a fluorocarbon resin.

The condition for the first heating treatment is preferably 330 to 350° C., and more preferably 330 to 340° C. (e.g., 330° C.). The heating time may only be enough for the temperature of the surface layer to sufficiently reach the desirable temperature. Examples thereof may include 1 to 20 minutes, 1 to 10 minutes, and 2 to 5 minutes. For example, the heating time is 3 minutes.

Then, a cooling step can be performed after heating. The cooling step is, for example, as follows. After completion of heating, cooling of the heating cylinder is performed. Cooling is performed by, for example, providing an air supply nozzle for air at the outer circumference of the heating cylinder, and adjusting the flow rate of air. A somewhat higher cooling rate is preferable so as to prevent an increase in spherulite diameter. Cooling is performed at a cooling rate of preferably 100 to 500° C./min, and more preferably 150 to 250° C./min. For example, the electrophotographic member may be taken out into the atmosphere (25° C.) for natural cooling, thereby achieving the cooling rate. Conceivably, by performing such quenching, a plurality of small spherulites are generated.

After sufficient cooling, a second heating treatment is performed. For the device, the same one as that for the first heating treatment can be used. By heating the surface layer again, and holding it for a given time, further crystallization proceeds. The heating temperature is preferably set within the range equal to or higher than the glass transition temperature and less than the full melting temperature so as to prevent the spherulite of a fluorocarbon resin first formed at the quenching step from being dissolved, and so as to progress the crystallization of the amorphous portion of the fluorocarbon resin yet to be crystallized. The condition for the second heating treatment is preferably 290 to 325° C., and more preferably 300 to 310° C. (e.g., 305° C.), for example, when the fluorocarbon resin is PFA.

The heating time may only be enough for the temperature of the surface layer to sufficiently reach the desirable temperature, and to allow holding for a given time or longer at a temperature at which crystallization can progress. The time is preferably 1 to 20 minutes, 1 to 10 minutes, and 2 to 5 minutes (e.g., 3 minutes).

By performing heating, namely, annealing at a temperature of less than the full melting temperature, the portion not to be crystallized at the first heating treatment is also crystallized, resulting in an increase in degree of crystallinity. The crystal generated at the second heating treatment is considered to be a crystal that is more stable and has a high degree of crystallinity, and to be a crystal that can correspond to the peak P1. Then, as described above, a small crystal of a spherulite is generated by quenching at the first heating treatment. For this reason, conceivably, even when the degree of crystallinity is improved, the spherulite is less likely to be enlarged.

Subsequently, cooling may be performed in the same manner as in the first heating treatment. Cooling is performed at a cooling rate of preferably 100 to 500° C./min, and more preferably 150 to 250° C./min. For example, the electrophotographic member may be taken out into the atmosphere (25° C.) for natural cooling, thereby achieving the cooling rate.

Further, in order to satisfy the relationship of T1>T2, for example, mention may be made of a means for performing the second heating treatment at a temperature close to the melting point of the raw material for the PFA tube.

The melting point herein referred to is the temperature of the peak top of the temperature lowering profile obtained by carrying out the heat amount measurement in which the following steps (1) and (2) are sequentially performed using a differential scanning calorimeter (DSC) with the sample sampled from the surface layer of the electrophotographic member as a measurement sample.
Step (1): a first temperature raising step of heating the measurement sample from a temperature of 25° C. to a temperature of 400° C. at a ramp rate of 20° C./min (holding at 400° C. for 5 minutes after temperature raising); and
Step (2): a first temperature lowering step of cooling the measurement sample heated to a temperature of 400° C. at the step (1) to a temperature of 25° C. at a ramp down rate of 20° C./min.

T1−T2 can be increased by increasing the heating temperature of the second heating treatment, and setting the heating temperature close to the full melting completion temperature. T1-T2 can be reduced by lowering the second heating temperature, and setting the temperature close to the melting start temperature. The inflection point on the higher temperature side of the temperature lowering profile is referred to as the full melting completion temperature, and the inflection point on the lower temperature side is referred to as the melting start temperature.

Further, the endothermic quantity in the first DSC chart obtained in the first temperature raising process of the step (1) is the endothermic quantity resulting from the crystal melting of a fluorocarbon resin. By dividing the value of the endothermic quantity of a fluorocarbon resin by the perfect crystal fusion heat of a fluorocarbon resin (92.9 J/g in the case of PFA), it is possible to calculate the degree of crystallinity of PFA.

The endothermic quantity of a fluorocarbon resin in the measurement sample determined from the first DSC chart is preferably 21 J/g or more, and more preferably 24 J/g or more. An endothermic quantity of 21 J/g or more results in a more favorable wear resistance to a paper sheet. Further, an endothermic quantity of 24 J/g or more results in a furthermore favorable wear resistance. The endothermic quantity of a fluorocarbon resin is preferably 21 to 40 J/g, and more preferably 24 to 30 J/g.

The endothermic quantity of a fluorocarbon resin can be controlled by performing heating to a temperature equal to or higher than the melting point, and then, controlling the cooling rate for promoting/suppressing the crystallization.

Although the specific method has no particular restriction, mention may be made of, for example, a means of carrying out the first heating treatment.

Further, preferably, T1 is 320° C. or less, and t1 is 290° C. or less. This is because the melting point of the raw materials for the fluorocarbon resin is low, and the molecular chain has a certain degree of flexibility.

Further, preferably, T1 is 300° C. or more, and t1 is 270° C. or more. As a result, the crystallization temperature in the fluorocarbon resin is sufficiently high, and the degree of crystallinity becomes high. Accordingly, the wear resistance becomes more favorable.

Therefore, T1 is preferably 300 to 320° C., more preferably 303 to 317° C., and further preferably 305 to 315° C. t1 is preferably 270 to 290° C., more preferably 280 to 290° C., and further preferably 280 to 288° C.

T1 can be increased by, for example, increasing the heating treatment temperature of the second heating treatment. T1 can be reduced by, for example, reducing the heating treatment temperature of the second heating treatment.

t1 can be increased by using a fluorocarbon resin with a high melting point. t1 can be reduced by using a fluorocarbon resin with a low melting point.

Further, T2 is preferably 290 to 310° C., and more preferably 295 to 305° C.

Incidentally, the differential scanning calorimetric measurement (DSC) in the present disclosure shall be in accordance with Japanese Industrial Standards (JIS) K7121-2012 unless otherwise mentioned.

The thickness of the surface layer is preferably 10 to 100 μm, and more preferably 15 to 40 μm. When the thickness of the surface layer is 10 μm or more, the degree of crystallinity tends to be increased, and the wear resistance becomes more favorable. When the thickness of the surface layer is 100 μm or less, the surface property is improved, so that the image gloss value becomes more likely to be improved.

The formation method of the surface layer has no particular restriction. As one example for satisfying the T1, T2, and the like, the following method can be used. Herein, an example using a PFA tube for manufacturing the surface layer 41a will be taken. However, the surface layer is not limited to the one formed using a PFA tube. The surface layer is more preferably a PFA tube, and is, for example, an extruded PFA tube.

The PFA tube can be manufactured by, for example, extruding a molten PFA from a cylindrical die. Such a PFA tube is quenched in the extruding process, so that crystallization rapidly progresses. Accordingly, the crystal is oriented in the extrusion direction, and further the degree of crystallinity is in a low state. The PFA tube is coated on the surface of the elastic layer 41c, resulting in a surface layer 41a. Then, the heating treatment of the surface layer is performed. The heating treatment can increase the degree of crystallinity, and a spherulite is formed on the surface layer surface.

The means for coating the PFA tube on the surface of the elastic layer has no particular restriction, and a known means can be adopted. For example, a method in which a fluorocarbon resin tube is externally expanded, and is coated (expansion coating method) can be used. An expansion coating method in which a PFA tube is externally vacuum expanded, and the like can be used.

The measurement method of each physical property in the present disclosure will be shown below.

### Measurement Method of an Endothermic Peak Temperature and Endothermic Quantity

First, the surface layer is isolated from the fixing member. Specifically, the surface layer is released together with the elastic layer from the base layer, and the elastic layer bonded with the surface layer is dissolved by a solvent. As a result, only the surface layer can be isolated. From the isolated surface layer, an about 2 mm×2 mm sample is cut out so as to fit into the DSC measuring pan.

The endothermic peak temperature and the endothermic quantity are measured using a differential scanning colorimetry device (trade name: Q2000, manufactured by TA Instruments Co.). For the temperature correction of the device detection part, the melting points of indium and zinc are used. For the correction of the heat amount, the heat of fusion of indium is used. Specifically, the surface layer is weighed in an amount of 4 mg, and is placed in a pan made of aluminum. As the reference, an empty pan made of aluminum is used. The temperature raising and the temperature lowering are as in the steps (1) to (4). From the obtained first DSC chart and second DSC chart, T1, t1, and T2 are determined.

Further, in the first DSC chart obtained at the step (1), the area surrounded by the endothermic peak-containing temperature-endothermic quantity curve and the baseline is referred to as the endothermic quantity.

### Determination Method of Peak

The “peak” in the present disclosure is determined in the following manner. In the DSC chart (which is also referred to as the DSC curve) (horizontal axis; temperature [° C.], vertical axis; Heat Flow [W/g]) obtained with DSC of the surface layer, the DSC curve at that time is assumed to be f(x). The curve is differentiated, thereby determining the value of x for f′(x)=0. Out of the x's, the x whose peak of the curve at the position is convex on the negative side is position of the peak top. Further, in the present disclosure, when the line connecting the values of f(200) to f(350) is assumed to be the baseline, and this is referred to as g(x), the size of the peak is determined by the value of f(x)-g(x) of the position of the peak top.

### Measurement Method of Thickness of Surface Layer

The thickness of the surface layer in the present disclosure is measured in the following manner.

First, the surface layer is isolated from the electrophotographic member in the same manner as in the measurement of the endothermic peak temperature and the endothermic quantity. Then, the thickness of the isolated surface layer is measured using a micrometer. As the micrometer, for example, a high-accuracy digimatic micrometer (trade name: MDH-25 MB; manufactured by Mitutoyo Corporation), or the like can be used.

### Electrophotographic Image Forming Apparatus

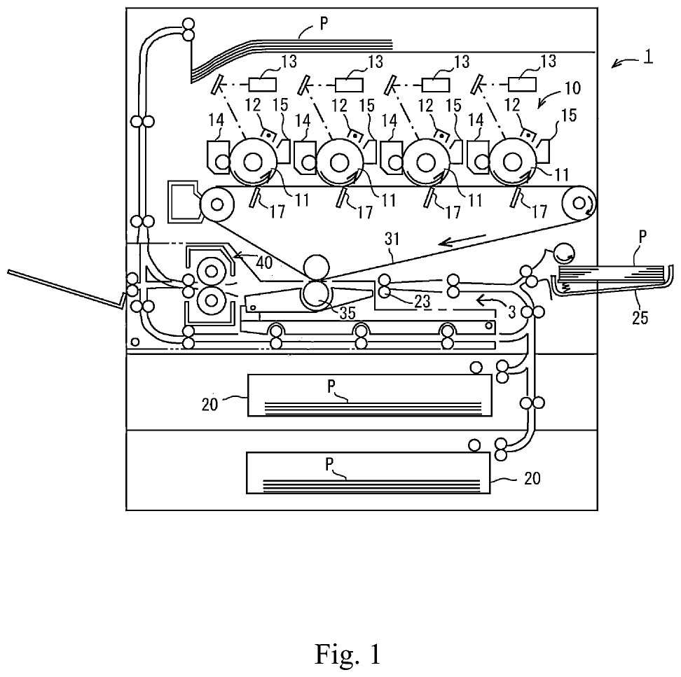

FIG. 1 is a cross sectional view of a color electrophotographic printer of one example of an electrophotographic image forming apparatus (which will be hereinafter also referred to as an “image forming apparatus”) of the present embodiment, and a cross sectional view along the transport direction of the recording material. In the present embodiment, the color electrophotographic printer is referred to simply as a “printer”.

A printer 1 shown in FIG. 1 includes an image forming part 10 of each color of Y (yellow), M (magenta), C (cyan), and Bk (black). A photosensitive drum (photosensitive member) 11 is previously charged by a charging device 12. Subsequently, the photosensitive drum 11 is exposed by a laser scanner 13, so that an electrostatic latent image is formed. The electrostatic latent image becomes a toner image by a developing device 14. The toner image of the photosensitive drum 11 is sequentially transferred to, for example, an intermediate transfer belt 31, i.e., an image bearing member by a primary transfer blade 17. After transfer, the toner left on the photosensitive drum 11 is removed by a cleaner 15. As a result of this, the surface of the photosensitive drum 11 becomes clean, and gets ready for the next image formation.

On the other hand, recording materials P are fed one by one in the direction of an arrow 3 from a paper supply cassette 20 or a multi-paper supply tray 25, and are fed into a resist roller pair 23. The resist roller pair 23 once receives the recording material P, and straightens the recording material P when the recording material P goes obliquely. Then, the resist roller pair 23 feeds the recording material P into between the intermediate transfer belt 31 and a second transfer roller 35 in synchronization with the toner image on the intermediate transfer belt 31. The color toner image on the intermediate transfer belt is transferred onto the recording material P by, for example, the second transfer roller 35, i.e., a transfer member. Subsequently, the toner image on the recording material P is fixed on the recording material P by heating and pressurization of the recording material P by a fixing apparatus 40.

The electrophotographic image forming apparatus includes the fixing apparatus 40. Then, the fixing apparatus in the electrophotographic image forming apparatus will be described. The fixing apparatus includes a fixing member and a pressurizing member arranged opposed to the fixing member. FIG. 2 is a schematic block view of the fixing apparatus 40, and is an example of a film heating system heating device (tensionless type). In the present Example, such a heating device was used. However, the process can be carried out even with a roller pair system or film system heating device.

Ref No. 43 represents a ceramic heater (which will be hereinafter described as a heater) as a heating member. The heater 43 includes a long and narrow thin sheet-shaped ceramic substrate with the direction perpendicular to the drawing as the longitudinal direction, and a current carrying heat generating resistance layer provided on the substrate surface as the basic configuration. The heater 43 is a heater with a low heat capacity which is raised in the temperature entirely with a steep rise characteristic due to the passage of a current through the heat generating resistance layer. Further, it is configured such that the current passage region is switched according to the longitudinal width size of the recording material P.

An electrophotographic member in accordance with at least one aspect of the present disclosure can be used as, for example, a fixing member. The fixing film 41 is a cylindrical (endless) heat-resistant fixing member as a heating member for transmitting heat, and is loose fitted onto the support member (heater holder) including the heater 43. The fixing film 41 has a structure as shown in FIG. 3, and is a fixing film having a 3-layer composite structure including at least the surface layer 41a, the elastic layer 41c, and the base layer 41b.

A pressure roller 44 is a heat resistant elastic pressure roller as a pressurizing member, and has a core metal, and an elastic layer including a foamed product of heat resistant rubber such as silicone rubber or fluorocarbon rubber, or silicone rubber. The both ends of the core metal are arranged in a rotatably bearing supported manner. Incidentally, an electrophotographic member in accordance with at least one aspect of the present disclosure can also be used as, for example, a pressurizing member. Namely, at least one of the fixing member and the pressurizing member is preferably the electrophotographic member. For example, the pressurizing member can have the same configuration as that of the fixing film 41. The pressurizing member can have a 3-layer composite structure including the surface layer 41a, the elastic layer 41c, and the base layer 41b.

On the upper side of the pressure roller 44, the fixing film 41/heater 43 are arranged in parallel with the pressure roller 44, and are pressed by a pressing member not shown. With such a configuration, the lower surface of the heater 43 and the upper surface of the pressure roller 44 are pressure welded via the fixing film 41 against the elasticity of the elastic layer 41c. As a result, a fixing nip part with a prescribed width can be formed as the heating part.

The pressure roller 44 is rotatively driven at a prescribed rotation circumferential velocity in a counterclockwise direction indicated with an arrow by a driving means not shown. The pressure welding frictional force at the fixing nip part between the pressure roller 44 and the fixing film 41 due to the rotational driving of the pressure roller 44 causes the rotatory power to act on the cylindrical fixing film 41. Then, the fixing film 41 is in a driven rotational state in the clockwise direction indicated with an arrow while sliding in close contact with the downward-facing surface of the heater 43. A support member (heater holder) 46 is also a rotational guide member of the cylindrical fixing film 41.

The pressure roller 44 is rotatively driven, accordingly, the cylindrical fixing film 41 is rendered in a driven rotational state. Further, the heater 43 is energized, so that the heater is rapidly raised in temperature, and rises at a prescribed temperature, resulting in a temperature adjusted state. In such a state, a recording material P bearing an unfixed toner image T is introduced into between the fixing film 41 and the pressure roller 44 at the fixing nip part. Then, the toner image bearing side surface of the recording material P comes in close contact with the outside surface of the fixing film 41 at the fixing nip part, and is sandwiched and transported together with the fixing film 41 to the fixing nip part. The heat of the fixing film 41 heated by the heater 43 in the sandwiching and transporting process heats the recording material P. The unfixed toner image T on the recording material P is heated/pressed on the recording material P, to be molten and fixed. The recording material P which has passed through the fixing nip part T is self-stripped from the surface of the fixing film 41, to be discharged and transported.

A reference No. 45 represents a contact type thermometer (thermistor), and is configured to measure the temperature of the fixing film 41 heated by the heater 43, and to pass the detection result to a temperature controlling means not shown. A reference No. 46 represents a heater holder, and a member for holding the heater 43 which has generated heat to a high temperature.

### EXAMPLES

Below, the present disclosure will be described in further details by way of Examples and Comparative Examples. However, the aspect of the present disclosure is not limited thereto.

### Example 1

In the present Example, a fixing film as shown in FIG. 3 was manufactured.

### Base Layer

A SUS with an inside diameter of 24 mm, and a thickness of 30 μm was used as the base layer.

### Formation of Inner Surface Sliding Layer

First, aromatic tetracarboxylic acid dianhydride or a derivative thereof and aromatic diamine were allowed to react with each other in substantially equimolar amounts in an aprotic polar organic solvent, resulting in a polyimide precursor solution. The resulting polyimide precursor solution was coated onto the internal circumferential surface of the base layer by a ring coating method. The solvent was dried in an electric furnace, and then was heated at 260 to 400° C. for about 1 hour, thereby forming an inner surface sliding layer. The thickness of the inner surface sliding layer was set at 12 μm.

### Formation of Primer Layer and Elastic Layer

A primer layer and an elastic layer were formed with respect to the base layer including the inner surface sliding layer formed thereon with the following procedure.

A hydrosilyl type silicone primer (DY39-051 A/B; manufactured by DOW and TORAY Co.) was coated onto the base layer, and was heated and cured at 200° C. for 5 minutes. On the primer layer, a liquid addition curable silicone rubber mixture including the following components (a) to (d) mixed therein was coated with a thickness of 250 μm, and was heated and cured at 200° C. for 30 minutes, thereby forming a silicone rubber elastic layer with a thickness of 250 μm.

### Silicone Rubber Mixture

Component (a): linear chain type organopolysiloxane having an unsaturated aliphatic group
Component (b): organopolysiloxane having active hydrogen bonded with silicon
Component (c): a catalyst
Component (d): a thermally conductive filler

First, as the component (a), 100 parts by mass of a silicone polymer having a vinyl group, i.e., an unsaturated aliphatic group at only each opposite end of the molecular chain, and having a methyl group as a non-substituted hydrogen carbide group not including other unsaturated aliphatic groups was prepared. The silicone polymer (trade name: DMS-V35, manufactured by Gelest Co., viscosity 5000 mm²/s) will be hereinafter referred to as “Vi”.

Then, to the Vi, alumina (trade name: ALUNABEADS CB-P10, manufactured by Showa Denko Co., Ltd.) was added in an amount of 370 parts by mass as the component (d), and the mixture was set in a rotation-revolution mixer (ARV-5000 manufactured by THINKY Co.,), and was mixed with stirring for two minutes at 600 rpm, resulting in a mixture 1.

Then, the one obtained by dissolving 0.2 part by mass of 1-ethynyl-1-cyclohexanol (manufactured by Tokyo Chemical Industry Co.) of a curing retardant in the same weight of toluene was added into the mixture 1, resulting in a mixture 2.

Then, as the component (c), a hydrosilylated catalyst (platinum catalyst: a mixture of 1,3-divinyl tetramethyldisiloxane platinum complex, 1,3-divinyl tetramethyldisiloxane, and 2-propanol) was added in an amount of 0.1 part by mass into the mixture 2, resulting in a mixture 3.

Further, as the component (b), a silicone polymer having a linear siloxane skeleton and having an active hydrogen group bonded with silicon only at the side chain (trade name: HMS-301, manufactured by Gelest Co, viscosity 30 mm²/s, which will be hereinafter referred to as “SiH”) was weighed in an amount of 1.1 parts by mass. This was added to the mixture 3, and was sufficiently mixed, resulting in a liquid addition curable silicone rubber mixture.

### Coating of Adhesive Layer

After forming the elastic layer, an adhesive (SE1819CV A/B; manufactured by DOW and TORAY Co.) was coated with a thickness of 7 μm on the elastic layer using the ring coating method.

### Formation of Surface Layer

After coating the adhesive, as the surface layer, a PFA tube which has already undergone an inside surface treatment (raw material: AP-231SH (manufactured by DAIKIN INDUSTRIES Ltd.)) was coated on the adhesive with a method for external vacuum expansion and coating (vacuum expansion coating method).

Specifically, the inside surface of an external cylinder having a larger inside diameter than the outside diameter of a work after forming the elastic layer coated with the adhesive is allowed to adsorb the PFA tube in a vacuum state for diameter expansion, and the work was inserted thereinto. Then, the vacuum was released, resulting in coating on the adhesive. The extra adhesive and air between the PFA tube and the elastic layer was stripped off by an O ring, or the like. Then, by a heating means such as an electric furnace, the adhesive was cured/bonded. Specifically, using an electric furnace, heating was performed at 200° C. for 2 minutes. Thereafter, both the ends were cut to a desirable length (336.5 mm).

### Heating Treatment of Surface Layer

After cutting both the ends to a desirable length, the resulting sample was inserted into a heating cylinder with an inside diameter of q42 mm, and the entire region was subjected to a heating treatment by a band heater inside of the heating cylinder. The heating temperature was set at 330° C., and the heating treatment was performed so that the real temperature of the surface layer may become equal to or higher than the melting temperature of PFA.

The heating time was set at 3 minutes after charging the fixing film into the heating cylinder as the time capable of sufficiently allowing the real temperature of the surface layer to reach the desirable heating treatment temperature. After an elapse of 3 minutes after charging, the fixing film was taken out from the heating cylinder to under normal temperature atmosphere, and was cooled to a normal temperature (25° C.) at a cooling rate of 200° C./min (first heating treatment).

Then, as the second heating treatment, the fixing film was charged into a heating cylinder whose heating treatment temperature was set at 305° C., and the entire region thereof was subjected to a heating treatment again. The heating time was set at 3 minutes after charging of the fixing film into the heating cylinder as the time capable of allowing the real temperature of the surface layer to sufficiently reach a desirable heating treatment temperature, and allowing progress of crystallization. After an elapse of 3 minutes from charging, the fixing film was taken out from the heating cylinder to under normal temperature atmosphere, and cooling was performed to a normal temperature (25° C.) at a cooling rate of 200° C./min, resulting in a fixing film.

With a sample sampled from the surface layer of the fixing film as a measurement sample, heat amount measurement in which using a differential scanning calorimeter (DSC), the following steps (1) to (4) are sequentially performed was carried out.
Step (1): a first temperature raising step of heating the measurement sample from a temperature of 25° C. to a temperature of 400° C. at a ramp rate of 20° C./min (holding at 400° C. for 5 minutes after temperature raising);
Step (2): a first temperature lowering step of cooling the measurement sample heated to a temperature of 400° C. at the step (1) to a temperature of 25° C. at a ramp down rate of 20° C./min;
Step (3): a second temperature raising step of raising the temperature of the measurement sample set at a temperature of 25° C. at the step (2) to a temperature of 400° C. at a ramp rate of 20° C./min (holding at 400° C. for 5 minutes after temperature raising); and
Step (4): a second temperature lowering step of cooling the measurement sample heated to a temperature of 400° C. at the step (3) to a temperature of 25° C. at a ramp down rate of 20° C./min;

In the first DSC chart obtained at the step (1), at least two endothermic peaks were identified. P1 represents the peak situated on the higher temperature side when two endothermic peaks are selected sequentially from the largest one of the at least two endothermic peaks, P2 represents the endothermic peak situated on the lower temperature side, T1° C. represents the peak top temperature of P1, and t1° C. represents the peak top temperature of P2.

Further, in the second DSC chart obtained at the step (3), at least one endothermic peak is identified. T2° C. represents the peak top temperature of the largest endothermic peak of the at least one endothermic peak. In this manner, T1, t1, T2, and further the endothermic quantity of the endothermic curve obtainable at the step (1) were determined. The results are shown in Table 1.

### Evaluation of Wear Resistance

Evaluation of the wear resistance was performed using a film heating system fixing apparatus 40 shown in FIG. 2 including the manufactured fixing film built therein. With the pressurizing force set so as to be 156.8 N for one end side thereof, and to be 313.6 N (32 kgf) for the total pressurizing force, rotative driving was performed so that the moving speed (circumferential speed) of the pressure roller surface may become 320 mm/sec. With the paper feed part surface temperature of the fixing film controlled at 170° C., the same-sized paper sheets (A4 horizontal, GF-C068) were continuously fed at 70 sheets/min. When the results of the evaluation according to the following evaluation criteria were A to C, it was determined that the effects of the present disclosure was obtained.

### Evaluation Criteria

A: even when 500000 paper sheets are fed, abrasion of the surface layer is scarcely observed
B: even when 200000 paper sheets are fed, abrasion of the surface layer is scarcely observed, however when 500000 paper sheets are fed, slight abrasion of the surface layer due to the paper sheet end is observed
C: when 200000 paper sheets are fed, slight abrasion of the surface layer due to the paper sheet end is observed, and when 500000 paper sheets are fed, definite abrasion of the surface layer due to the paper sheet end is observed
D: When 200000 paper sheets are fed, definite abrasion of the surface layer due to the paper sheet end is observed

### Evaluation of Image Gloss Value

Evaluation of the image gloss value was performed using the fixing apparatus 40 of the same film heating system as that for the evaluation of the wear resistance. Under environment of a temperature of 23° C. and a relative humidity of 50%, with the paper feed part surface temperature of the fixing film controlled at 160° C., a black solid image was fixed. For the paper sheet, a A4-sized paper sheet (trade name: GFC-081 (81.0 g/m²); commercially available from CANON MARKETING JAPAN Co., Ltd.) was used. The 60° gloss of the outputted image was measured with a gloss meter (handy type gloss meter PG-1M manufactured by NIPPON DENSHOKU INDUSTRIES Co., Ltd.), and the average value thereof was evaluated according to the following criteria.

The 60° glass is the gloss value measured at an incident angle of 60°. In the case of the incident angle of 60°, the gloss value is the value when the specular reflectance (10%) of a light at the glass surface layer whose refractive index is 1.567 over the entire visible wavelength region is assumed to be 100. When the results of the evaluation according to the following evaluation criteria are A to C, it was determined that the effect of the present disclosure was obtained.

### Evaluation Criteria

A: gloss is 10 or more
B: gloss is 8 or more and less than 10
C: gloss is 6 or more and less than 8
D: gloss is less than 6

### Example 2

A fixing film was obtained in the same manner as in Example 1, except for changing the second heating treatment time to 2 minutes.

### Example 3

A fixing film was obtained in the same manner as in Example 1, except for changing the raw material for the PFA tube to 451HP-J (manufactured by Chemours-Mitsui Floropruducts Co., Ltd.), and changing the second heating treatment temperature to 315° C.

### Example 4

A fixing film was obtained in the same manner as in Example 1, except for changing the raw material for the PFA tube to 959HP-Plus (manufactured by Chemours-Mitsui Floropruducts Co., Ltd.), and changing the second heating treatment temperature to 295° C.

### Example 5

A fixing film was obtained in the same manner as in Example 1, except for changing the second heating treatment temperature to 315° C.

### Example 6

A fixing film was obtained in the same manner as in Example 1, except for setting the thickness of the PFA tube at 10 μm.

### Example 7

A fixing film was obtained in the same manner as in Example 1, except for setting the thickness of the PFA tube at 100 μm.

### Example 8

A fixing film was obtained in the same manner as in Example 1, except for changing the second heating treatment time to 1 minute.

### Example 9

A fixing film was obtained in the same manner as in Example 1, except for changing the raw material for the PFA tube to 451HP-J (manufactured by Chemours-Mitsui Floroproducts Co., Ltd.), and changing the second heating treatment temperature to 325° C.

### Example 10

A fixing film was obtained in the same manner as in Example 1, except for changing the second heating treatment temperature to 325° C.

### Example 11

A fixing film was obtained in the same manner as in Example 1, except for setting the thickness of the PFA tube at 9 μm.

### Example 12

A fixing film was obtained in the same manner as in Example 1, except for setting the thickness of the PFA tube at 110 μm.

### Comparative Example 1

A fixing film was obtained in the same manner as in Example 1, except for omitting the heating treatment step of the surface layer.

### Comparative Example 2

A fixing film was obtained in the same manner as in Example 1, except for omitting the second heating treatment step and the steps subsequent to the second heating treatment step of the heating treatment steps of the surface layer.

### Comparative Example 3

A fixing film was obtained in the same manner as in Example 1, except for providing an air supply nozzle for air at the outer circumference of the heating cylinder, adjusting the flow rate of air from the completion of the first heating treatment, thereby controlling the heating cylinder so as to set the cooling rate at a cooling rate of 20° C./min, and taking out the fixing film after the temperature became normal temperatures, and further omitting the second heating treatment step and the procedure subsequent to the second heating treatment.

### Comparative Example 4

A fixing film was obtained in the same manner as in Example 1, except for changing the temperature of the second heating treatment to 290° C.

The T1, t1, and T2, and the endothermic quantity of the endothermic curve obtained at the step (1) of each fixing film manufactured in Examples 2 to 12, and Comparative Examples 1 to 4 were determined. Further, the evaluation of the wear resistance and the image gloss value was performed on the basis of the same evaluation method as in Example 1. The results are shown in Table 1. Incidentally, when t1 could not be observed, namely, when there was no P2, the results are described as.

TABLE 1

| | Measurement results | | | | | | | Evaluation | |
|---|---|---|---|---|---|---|---|---|---|
| | | | | | | Endothermic | | Image | |
| | Number | T1 | t1 | T2 | | quantity | Thickness | gloss | Wear |
| | of peaks | [° C.] | [° C.] | [° C.] | T1-T2 | [J/g ] | [μm] | value | resistance |
| Example 1 | 2 | 308 | 287 | 302 | 6 | 25 | 20 | A | A |
| Example 2 | 2 | 308 | 287 | 302 | 6 | 21 | 20 | A | B |
| Example 3 | 2 | 320 | 290 | 310 | 10 | 25 | 20 | A | A |
| Example 4 | 2 | 300 | 270 | 290 | 10 | 21 | 20 | A | B |
| Example 5 | 2 | 317 | 287 | 302 | 15 | 21 | 20 | A | B |
| Example 6 | 2 | 308 | 287 | 302 | 6 | 21 | 10 | A | B |
| Example 7 | 2 | 308 | 287 | 302 | 6 | 27 | 100 | B | A |
| Example 8 | 2 | 308 | 287 | 302 | 6 | 19 | 20 | A | C |
| Example 9 | 2 | 325 | 295 | 310 | 15 | 20 | 20 | B | C |
| Example 10 | 2 | 303 | 280 | 302 | 1 | 21 | 20 | A | B |
| Example 11 | 2 | 308 | 287 | 302 | 6 | 19 | 9 | A | C |
| Example 12 | 2 | 308 | 287 | 302 | 6 | 28 | 110 | C | A |
| Comparative | 1 | 300 | — | 302 | −2 | 19 | 20 | D | D |
| Example 1 | | | | | | | | | |
| Comparative | 1 | 298 | — | 302 | −4 | 21 | 20 | C | D |
| Example 2 | | | | | | | | | |
| Comparative | 1 | 305 | — | 302 | 3 | 27 | 20 | D | B |
| Example 3 | | | | | | | | | |
| Comparative | 2 | 298 | 275 | 302 | −4 | 20 | 20 | B | D |
| Example 4 | | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-104709, filed Jun. 27, 2023, which is hereby incorporated by reference herein in its entirety.

What is claimed is:

1. An electrophotographic member comprising:
a base layer;
an elastic layer on the base layer, and
a surface layer on the elastic layer, wherein
the surface layer comprises a fluorocarbon resin,
when heat amount measurement in which the following steps (1) to (4) are sequentially performed with a sample sampled from the surface layer as a measurement sample using a differential scanning calorimeter (DSC),
step (1): a first temperature raising step of heating the measurement sample from a temperature of 25° C. to a temperature of 400° C. at a ramp rate of 20° C./min;
step (2): a first temperature lowering step of cooling the measurement sample heated to a temperature of 400° C. at the step (1) to a temperature of 25° C. at a ramp down rate of 20° C./min; and
step (3): a second temperature raising step of raising the temperature of the measurement sample set at a temperature of 25° C. at the step (2) to a temperature of 400° C. at a ramp rate of 20° C./min;
step (4): a second temperature lowering step of cooling the measurement sample heated to a temperature of 400° C. at the step (3) to a temperature of 25° C. at a ramp down rate of 20° C./min;
a first DSC chart obtained at the step (1) has at least two endothermic peaks, P1 represents a endothermic peak situated on a higher temperature side when two endothermic peaks are selected sequentially from the largest one of the at least two endothermic peaks, P2 represents a endothermic peak situated on a lower temperature side of the two endothermic peaks, T1° C. represents a peak top temperature of the P1, and t1° C. represents a peak top temperature of the P2, and
a second DSC chart obtained at the step (3) has at least one endothermic peak, and T2° C. represents a peak top temperature of the largest endothermic peak of the at least one endothermic peak, then,
the T1 and the T2 satisfy the following formula (1):
$$T 1 > T 2. \qquad ( 1 )$$

2. The electrophotographic member according to claim 1, wherein
the fluorocarbon resin comprises a tetrafluoroethylene-perfluoro alkyl vinyl ether copolymer.

3. The electrophotographic member according to claim 1, wherein
an endothermic quantity of the fluorocarbon resin of the measurement sample determined from the first DSC chart is 21 J/g or more.

4. The electrophotographic member according to claim 3, wherein
the endothermic quantity is 24 J/g or more.

5. The electrophotographic member according to claim 3, wherein
the endothermic quantity is 21 to 40 J/g.

6. The electrophotographic member according to claim 1, wherein
the T1 is 300 to 320° C., and
the t1 is 270 to 290° C.

7. The electrophotographic member according to claim 1, wherein
the T1 and the T2 satisfy the following formula (2):
$$T 1 - T 2 \leq 15 ° C . \qquad ( 2 ) .$$

8. The electrophotographic member according to claim 1, wherein
the electrophotographic member is an electrophotographic belt having an endless shape.

9. The electrophotographic member according to claim 1, wherein
a thickness of the surface layer is 10 to 100 μm.

10. The electrophotographic member according to claim 1, wherein
the electrophotographic member is a fixing belt.

11. A fixing apparatus in an electrophotographic image forming apparatus,
the fixing apparatus comprising a fixing member; and a pressurizing member arranged opposed to the fixing member, wherein
at least one of the fixing member and the pressurizing member is the electrophotographic member according to claim 1.

12. An electrophotographic image forming apparatus comprising a fixing apparatus, wherein
the fixing apparatus includes a fixing member; and a pressurizing member arranged opposed to the fixing member, and
at least one of the fixing member and the pressurizing member is the electrophotographic member according to claim 1.
